(19) United States
(12) Patent Application Publication
(10) Pub. No.: US 2008/0016011 A1
(43) Pub. Date: Jan. 17, 2008

(54) METHOD OF AND SYSTEM FOR SECURITY SOLD UNDER AGREEMENT TO REPURCHASE WITH OPTION TO LIQUIDATE

(75) Inventor: Dennis Kert MOORE, Dallas, TX (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Town North Bank N.A., Dallas, TX (US)

(21) Appl. No.: 11/777,506

(22) Filed: Jul. 13, 2007

Related U.S. Application Data
(60) Provisional application No. 60/830,802, filed on Jul. 13, 2006.

(51) Int. Cl. G06Q 40/00

(52) U.S. Cl. 705/36 R; 705/38

(57) ABSTRACT

A technique for obtaining a loan is disclosed. The technique allows an entity, such as a bank, to borrow money from another entity, such as a customer. Further, the technique allows the customer to recall all or a portion of the loan at any time in exchange for incurring a penalty.

### CROSS-REFERENCE TO RELATED APPLICATION

The present application claims priority to and incorporates by reference in its entirety U.S. Provisional Application No. 60/830,802 entitled “Method Of And System For Security Sold Under Agreement To Repurchase With Option To Liquidate,” filed Jul. 13, 2006.

### FIELD OF THE INVENTION

The present invention generally relates to a technique for borrowing money. More particularly, the invention relates to a technique for borrowing money in which the lender is able to recall all or a portion of the loan prior to the end of the loan's maturity term.

### BRIEF DESCRIPTION OF THE DRAWINGS

The invention, both as to its structure and operation together with the additional objects and advantages thereof are best understood through the following description of exemplary embodiments of the present invention when read in conjunction with the accompanying drawings.

FIG. 1 is a schematic diagram of relationships among parties according to an embodiment of the present invention.

FIG. 2 is a flow chart of a method for obtaining a loan according to an embodiment of the present invention.

FIG. 3 is a chart illustrating payments according to an embodiment of the present invention.

FIG. 4 is a graph of exemplary historical and current yield curves.

### DETAILED DESCRIPTION OF THE PREFERRED EMBODIMENTS

In general, certain embodiments of the invention allow an entity, such as a bank, to obtain a loan from another entity, such as a customer of the bank. In such embodiments, the loan is supported by collateral provided by the bank in the form of securities (e.g., mortgage backed securities). The customer receives monthly interest payments on the loan during its duration. Also, during the duration of the loan, the customer may demand that the bank return all or a portion of the loaned cash in exchange for the return of a corresponding portion of the collateral securities. Depending on the proportion of the total loan that the customer demands and when the demand occurs, the bank may deduct a penalty from the returned cash. At the end of the maturity term for the loan, the bank returns any remaining cash, and the customer returns any remaining collateral. Certain embodiments of the invention are discussed in greater detail below.

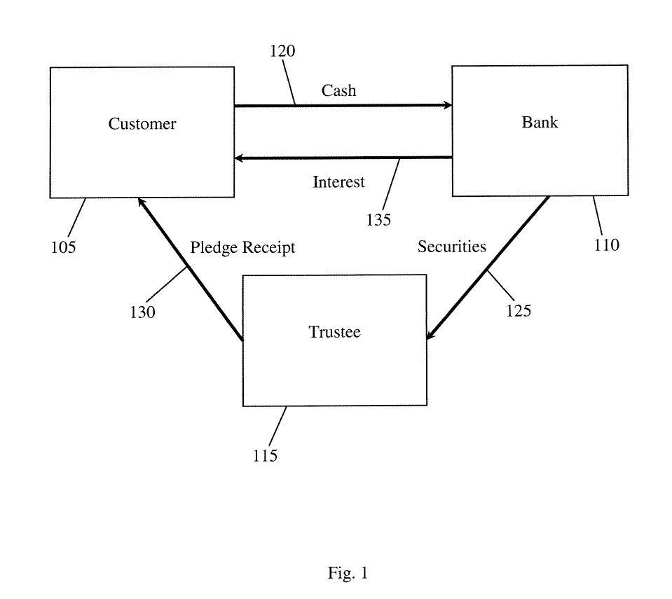

FIG. 1 is a schematic diagram of relationships among parties according to an embodiment of the present invention. In particular, the embodiment of FIG. 1 includes a bank 110, a customer 105 and a trustee 115. Although the embodiment of FIG. 1 includes bank 110 and customer 105, other entities are possible. Further, as explained below, trustee 115 may be omitted in some embodiments.

According to the embodiment of FIG. 1, bank 110 receives a loan from customer 105. That is, customer 120 conveys cash 120 to bank 110. In alternate embodiments, customer 120 may convey other valuable commodities to bank 110 in order to effect the loan. Such commodities include securities such as stocks and bonds. In return, bank 110 pays customer 105 interest 135 on the loan. Interest rates according to certain embodiments of the present invention are detailed below in reference to Table 1.

Continuing the discussion of FIG. 1, bank 110 puts up collateral for the loan in the form of securities 125. Such securities may include, by way of non-limiting example, mortgage backed securities. In this embodiment, trustee 115 holds the securities 125 on behalf of customer 105. Trustee 115 provides assurance to customer 105 that the securities are available to customer 105 by providing customer 105 with pledge receipt 130. In alternate embodiments bank 110 conveys collateral, such as securities 125, directly to customer 105. In such embodiments, trustee 115 may not be included. Regardless as to who holds the collateral, the bank compensates the customer for interest generated by the collateral while it remains collateral for the loan.

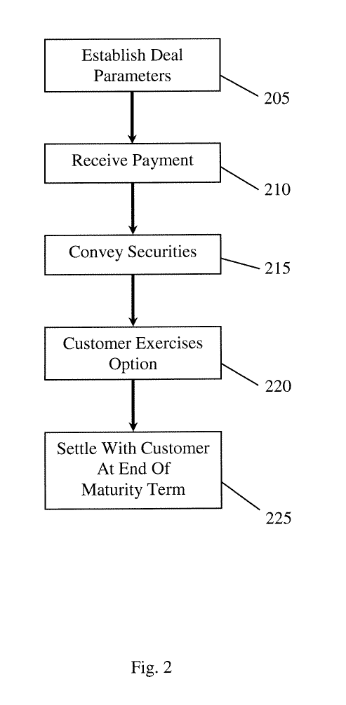

FIG. 2 is a flow chart of a method for obtaining a loan according to an embodiment of the present invention. The method begins by establishing the parameters of the loan at step 205. Such parameters include: loan amount, loan maturity term, the type of collateral, whether a trustee is included, the interest rate charged to the bank, and, as discussed in detail below, parameters related to the customer exercising its option to exchange some or all of the collateral in return for a corresponding loan amount prior to the loan maturity term.

Thus, at step 205, the bank and customer agree on a loan amount, which is typically provided in terms of funds such as U.S. dollars. Exemplary, non-limiting loan amounts include $10,000, $100,000, $500,000, $1,000,000, $2,000,000, $4,000,000 and $5,000,000. The parties further agree on a loan maturity term, the point in time after which the customer (or trustee) returns any remaining collateral to the bank and the bank settles with the customer as described in detail below. Maturity terms include, by way of non-limiting example, six months, one year, 18 months, two years, 30 months, three years, 42 months and four years.

The parties also agree on the type of collateral that will underlie the loan. Any type of security is contemplated as suitable collateral.

Some embodiments of the present invention utilize mortgage backed securities as collateral. Such securities are provided by, e.g., the Federal National Mortgage Association (“FNMA” or “Fannie Mae”) and the Federal Home Loan Mortgage Corporation (“FHLMC” or “Freddie Mac”). In general, mortgage backed securities are debt in the form of packages of mortgages.

Mortgage backed securities may pay their holder both interest and principal on a periodic (e.g., monthly) basis. In certain embodiments of the present invention that utilize mortgage backed securities as collateral, the customer receives payments from the bank that correspond to both interest and principal payments on the underlying security.

In general, should the collateral lose value during the pendency of the loan, the bank may replenish the same. By way of non-limiting example, for securities that have an associated pre-payment risk, such as mortgage backed securities, the bank ensures that the collateral retains its full value by adding collateral, if necessary, during the lifetime of the loan.

Table 1 below represents exemplary, non-limiting, interest rates charged to the bank according to certain embodiments of the present invention.

TABLE 1

| Maturity | | AAA- | FNHA or FHLMC |
|---|---|---|---|
| Term | A-Rated Collateral | Rated Collateral | Issued Collateral |
| 6 Months | 5.25% | 5.15% | 5.05% |
| 18 Months | 5.30% | 5.20% | 5.10% |
| 24 Months | 5.32% | 5.22% | 5.12% |
| 30 Months | 5.35% | 5.25% | 5.15% |
| 36 Months | 5.40% | 5.30% | 5.20% |
| 42 Months | 5.45% | 5.35% | 5.25% |
| 48 Months | 5.50% | 5.40% | 5.30% |

According to Table 1, the interest rate charged to the bank is dependant on both the maturity term and the rating of the security. In general, the longer the maturity term, the greater the interest rate. Further, the less risk associated with the collateral, the lower the interest rate. In general, securities may be rated as, e.g., “A” or “AAA” by Standard & Poor's in order to reflect their risk. Standard & Poors utilizes other ratings as well, which are contemplated within the scope of the invention. Other ratings agencies, such as Moody's and Fitch, Inc. use other ratings scales, and such scales may be used in addition or in the alternative to Standard & Poor's.

As reflected in Table 1, mortgage backed securities issued by FNHA or FHLMC are perceived as being very low risk and therefore associated with a relatively high credit rating. An issuer sells such securities with the understanding that the mortgage holders may pay off the mortgages early (i.e., that the securities include a pre-payment risk). Thus, mortgage backed securities are typically sold for less than the sum total of the underlying mortgages. Moreover, mortgage backed securities issued by FNHA or FHLMC are perceived as being guaranteed by the U.S. Federal Government and therefore are associated with very low (default) risk. Thus, the customer can be confident that such collateral will retain value during the lifetime of the loan. Accordingly, the interest rates charged to the bank when the collateral is a mortgage backed security issued by FNHA or FHLMC are relatively low in comparison with Standard & Poor's A or AAA rated securities as collateral.

At step 210, the bank receives the loan amount from the customer, and at step 215, the bank conveys the collateral securities to the customer or, in other embodiments, a trust as discussed above in reference to FIG. 1. These conveyances may be accomplished by hand, by wire transfer, via the internet, or by other techniques.

During the pendency of the loan, the bank periodically (e.g., monthly) pays the customer interest on the outstanding loan amount as represented in Table 1. In monthly payment embodiments, the bank pays the customer the interest rate applied to the outstandingly loan balance divided by twelve (corresponding to a monthly pro-rate). In some embodiments, the bank may also convey to the customer portions of the loan balance.

Step 220 of the embodiment of FIG. 2 represents that the customer may exercise its option to put back all, or a portion, of the collateral securities to the bank in exchange for a return of a corresponding portion of the loan amount. In return for exercising its option, the customer is charged a fee, which depends on both the time that the option is exercised and the proportion of the outstanding loan balance that the bank returns.

In the embodiment of FIG. 2, the customer is allowed to demand the return of all or a portion of the money loaned to the bank on the last day of every six-month “reset” interval, i.e., on a “reset date.” For example, if the loan begins on Jan. 1, 2007, the customer may demand that the bank return 50% of the originally-loaned money on Jul. 1, 2007. (Note that a six-month reset interval as described above is exemplary only and is not meant to limit the invention. Other reset intervals are also contemplated, such as monthly, quarterly and yearly.) The customer incurs a penalty on cash returns made on reset dates. Exemplary, non-limiting penalty amounts are illustrated below in Table 2.

TABLE 2

| Percentage of Outstanding | Interest Rate |
|---|---|
| Balance Demanded | Penalty |
| Less Than Or Equal To 50% | 0.30% |
| More Than 50% And Up To 75% | 0.40% |
| Over 75% | 0.60% |

As illustrated in Table 2, the embodiment of FIG. 2 applies a penalty to the interest rate provided to the bank for the returned cash. In the embodiment of FIG. 2, the penalty is calculated as the interest rate provided in Table 2 applied to the demanded amount over a (constructive) period of six months. That is, the penalty may be calculated as the rate provided in Table 2 multiplied by the demanded amount, divided by two (corresponding to six months worth of interest). For the reset interval at the end of which the demand is made, the bank may subtract the penalty from its payment to the customer. The returned cash may still accompanied by interest according to the rates illustrated in Table 1 for the periods other than the reset interval in which the demand is made (if such intervals exist—note that if the customer exercises its option at the end of the first reset interval, the penalty will cover the entire lifetime of the loan for the demanded amount).

In some embodiments, customers are allowed to demand all or a portion of the loaned cash be returned at any time, rather than only on specific reset dates. Such embodiments may charge a penalty on the returned cash in addition to the penalty depicted in Table 2. Such an additional penalty may be on the interest rate associated with the demanded cash over the entire period from the beginning of the loan until its demand date, or may be in addition to the one-time penalty rate provided in Table 2. In yet other embodiments, the customer may demand return of all or a portion of the loaned amount at any time, and will incur a single penalty on such cash (i.e., such embodiments omit the concept of reset dates).

At step 225, the parties settle the transaction. This normally occurs at the end of the transaction term, but may occur earlier, e.g., if the customer exercises its option to put back the entirety of the loan prior to the end of the maturity term. In general, for the embodiment of FIG. 2, the settlement occurs by the customer (or trustee) returning the collateral to the bank, and the bank paying the customer a cash settlement.

In general, the customer cash payments from the bank on a periodic basis. Each time that occurs, the payment includes interest and, if applicable, may exclude cash corresponding to one or more penalties. Such payments may further include portions of the loan balance (e.g., in embodiments that utilize mortgage backed securities, such amounts may correspond to principal payments). Thus, it is possible for a single transaction of the present invention to include the return of cash multiple times, each time with a different interest rate and penalty. Nevertheless, it is possible to associate a single rate of return to the entire transaction. This may be accomplished by, for example, computing the present value of each cash return as calculated at the time the loan commences, and then calculating an internal rate of return for the sum of the present values. Other techniques for calculating implied interest rates are also possible. The following examples illustrate the results of such calculations.

### EXAMPLE 1

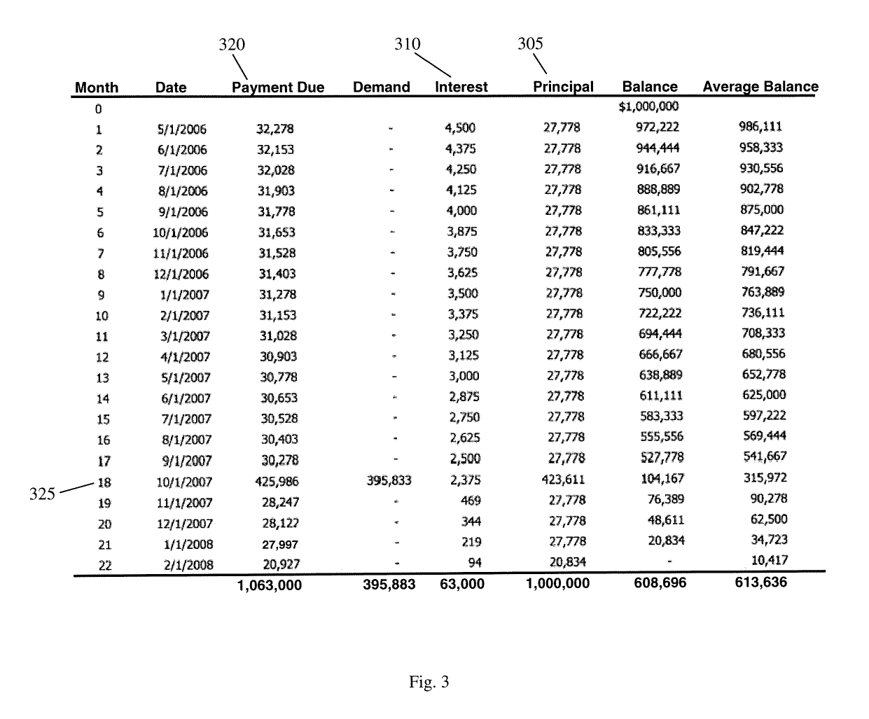

The customer loans the bank $1,000,000 for an eighteen month maturity term. The bank's collateral is A-rated, so the associated interest rate according to Table 1 is 5.30%. The bank's collateral is held by a trust. Initially, the customer receives interest of $4,417 each month (i.e., 5.30% of the $1,000,000 balance, pro-rated monthly). In this example, the loan balance is not paid back in periodic installments, thus the outstanding balance does not change except for demands; see FIG. 3 for an alternate arrangement. After one year, the customer demands that the bank return $500,000. According to Table 2, because $500,000 is 50% of the outstanding balance of $1,000,000, the corresponding penalty rate is 0.30%. The penalty is accordingly $750, calculated as the penalty rate of 0.30% applied to the demanded amount of $500,000 over a period of six months (0.30%×$500,000×(6 months/12 months)=$750). The penalty of $750 is subtracted from the demanded amount. After the demand, the loan balance is reduced to $500,000. Accordingly, the interest earned per month after the demand is $2,206, calculated as 5.30% of $500,000, pro-rated per month. At the end of eighteen months, the bank instructs the trust to return the remaining 50% of the loan amount, i.e. $500,000. The implied interest rate for the entire term of the loan is thus 5.22%, taking into account the $750 penalty.

### EXAMPLE 2

The customer loans the bank cash for a three-year term at a rate of 5.40%, and the bank puts up the associated collateral, which is held by the customer. After eighteen months, the customer demands return of 75% of the loan amount. The associated penalty is 0.40% on the demanded amount calculated over a constructive six-month period. Three years after the loan commences, the bank pays the customer the remaining 25% of the loan plus interest at 5.40%. The implied interest rate is accordingly 5.35% for the life of the loan.

### EXAMPLE 3

The customer and the bank enter into a transaction where the bank puts up security collateral in return for the customer loaning the bank cash for a four-year term. The collateral is associated with a 5.50% interest rate. After one year, the customer demands return of the entire loan amount. The associated penalty is 0.60%, and the implied interest rate for this deal is accordingly 5.24%.

FIG. 3 is a chart illustrating payments according to an embodiment of the present invention. In the embodiment of FIG. 3, the initial maturity term is set for three years, the loan amount is $1,000,000, the interest rate is 5.40%, and the loan amount is paid back in monthly installments. Because the maturity term is 36 months, the bank pays the customer the principal 305 in monthly installments of $1,000,000÷36=$27,778. Each month, the bank also pays the customer interest 310 in the form of a pro-rated 5.40% of the balance. The sum of the principal and interest is reflected in Payment Due column 320.

At month 18, the customer demands 75% of the outstanding balance of $527,778, or $395,833, depicted in row 325. The corresponding penalty rate is 0.40%. Thus, the penalty amount is calculated as what interest on the demanded amount of $395,833 at a rate of 0.40% would be over a six-month period, or $792. In the embodiment of FIG. 3, the customer pays this penalty in cash, not reflected in FIG. 3. In month 19, the outstanding balance is $76,389; accordingly, the interest paid is $469.

Because the customer demanded early partial return of the loaned amount, the loan terminates at month 22, when the outstanding principal is reduced to zero. Although the interest rate corresponding to interest payments 310 is 5.40%, the implied interest rate after accounting for the $792 penalty is 5.33%.

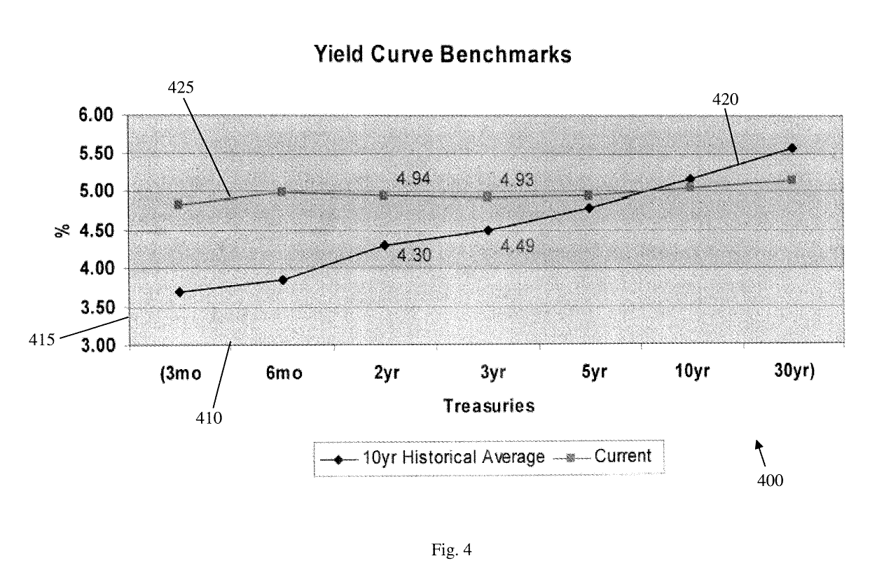

FIG. 4 is a graph of exemplary historical and current yield curves. In particular, FIG. 4 illustrated how certain embodiments of the present invention allow a customer to obtain an interest rate on its loan that would normally be associated with a loan having a longer maturity term. FIG. 4 illustrates two yield curves, a flat curve 425 and positively-sloped (or “normal”) curve 420. When the yield curve for treasury bonds is flat, as in curve 425, there is no advantage in buying bonds with a longer maturity term, because the interest rate is the same for all terms. Conversely, with a normal yield curve, as 420, the longer the term, the better the interest rate Because certain embodiments of the present invention utilize collateral, such as mortgage backed securities, that have a longer maturity term than the loan between the bank and its customer, the loan interest rate may be higher than would otherwise obtain. For example, the bank may utilize as collateral mortgage backed securities where the underlying mortgages have thirty-year terms. Such assets provide a higher interest rate (assuming the yield curve is normal) to their holder than would be provided to a holder of, for example, treasury notes with a five-year term. Thus, customers in possession (either directly or through a trust) of collateral according to certain embodiments of the present invention are afforded a greater interest rate than would otherwise be available.

Certain embodiments of the present invention allow a customer to obtain principal protection above and beyond that which is provided by the FDIC for a single investment. In general, the FDIC insures investors for only $100,000 per bank in which an investment is deposited. Thus, if a customer relies on collateral for a loan in the form of bank deposits, the collateral would have to be spread across multiple banks if the collateral involved multiples of $100,000 in order for the customer to achieve full insurance protection. Certain embodiments of the present invention, on the other hand, allow customers to rely on collateral in the form of securities, such as mortgage backed securities. Such embodiments benefit from utilizing collateral that is backed by, e.g., FNMA or FHLMC, which are perceived as being guaranteed by the U.S. Government. Accordingly, certain embodiments allow customers to benefit from a single repository of collateral that still receives significant protection.

Certain embodiments of the present invention omit an exchange of collateral. In such embodiments, the customer loans money to the bank, but the bank does not provide collateral for the loan. The bank pays interest to the customer; in general, such embodiments include a higher interest rate than embodiments in which the bank supplies collateral. Further, such embodiments include the ability for the customer to demand a return of all or a portion of the loaned amount before the end of the maturity term. The details of such demands are essentially the same as in embodiments that utilize collateral.

The terminology used herein is for the purpose of describing particular embodiments only, and is not intended to limit the scope of the present invention. Unless defined otherwise, all technical, financial and scientific terms used herein have the same meanings as commonly understood by one of ordinary skill in the art to which this invention belongs. As used throughout this disclosure, the singular forms “a,” “an,” and “the” include plural reference unless the context clearly dictates otherwise.

We claim:

1. A method of receiving loan from a customer, the loan being backed by collateral, wherein the customer has the ability to recall the loan prior to an expiration of the loan, the method comprising:
establishing a maturity term;
receiving cash from the customer, the cash being associated with a first quantity of securities and with the maturity term;
conveying the first quantity of securities to an entity selected from the set consisting of the customer and a trustee for the customer;
receiving a demand from the customer at a time of the customer's choosing and prior to an end of the maturity term, the demand comprising information reflecting a second quantity, the second quantity being no greater than the first quantity;
obtaining, in response to the step of receiving a demand, the second quantity of securities from the entity; and
providing to the customer, in response to the step of receiving a demand, an amount of cash, the amount of cash corresponding to the second quantity of securities minus a penalty plus a quantity of interest, wherein the penalty is determined according to the time of the customer's choosing and a proportion of an outstanding balance represented by the second quantity.

2. The method of claim 1, wherein the first quantity of securities comprise mortgage backed securities.

3. The method of claim 1, further comprising replacing at least a portion of the first set of securities in response to the securities losing value.

4. The method of claim 1, wherein the method is performed by a bank.

5. The method of claim 1, further comprising periodically paying to the customer a portion of the outstanding balance.

6. A method for obtaining a loan from a customer, the method comprising:
agreeing on a maturity date, a loan amount, a collateral, and an interest rate;
receiving a first amount of cash from the customer to establish a loan balance;
providing collateral, the collateral comprising securities;
periodically paying interest to the investor, the interest corresponding to the loan balance and the interest rate;
receiving a demand from the customer on a demand date prior to the maturity date, the demand indicating a second amount of cash;
calculating a penalty, the penalty calculated as a function of the demand date and the second amount of cash as a proportion of the outstanding balance;
conveying a third amount of cash to the customer, the third amount of cash comprising the second amount of cash minus the penalty; and
receiving a quantity of collateral corresponding to the second amount of cash.

7. The method of claim 6, wherein the step of receiving a demand comprising receiving the demand over a computer network.

8. The method of claim 6, wherein the step of calculating a penalty comprising calculating the penalty using a computer.
